(19) United States
(12) Patent Application Publication
(10) Pub. No.: US 2024/0362867 A1
(43) Pub. Date: Oct. 31, 2024

(54) DEFINING BORDERS AND NEIGHBORS IN A METAVERSE

(71) Applicant: International Business Machines Corporation, Armonk, NY (US)

(72) Inventors: Guang Han Sui, Beijing (CN); Peng Hui Jiang, Beijing (CN); Jun Su, Beijing (CN); Su Liu, Austin, TX (US); Yu Zhu, Beijing (CN)

(21) Appl. No.: 18/139,253

(22) Filed: Apr. 25, 2023

(51) Int. Cl. G06T 19/00

(52) U.S. Cl. CPC G06T 19/006; G06T 19/003

(57) ABSTRACT

A computer-implemented method, according to one embodiment, includes outputting, from a first user device associated with a first user that owns a first portion of land in a metaverse to a second user device associated with a second user that owns a second portion of land in the metaverse, a first request for being defined as a first neighbor of the first user. In response to a determination that an acceptance has been received from the second user device to be defined as the first neighbor of the first user, an adapter is caused to be added to a sub-portion of the first portion of land and a sub-portion of the second portion of land. The method further includes generating a definition of neighbors of the first portion of land, the definition including the first neighbor. The definition is caused to be recorded in a predetermined database.

### BACKGROUND

The present invention relates to virtual reality environments such as the metaverse, and more specifically, this invention relates to defining borders and neighbors in a metaverse.

Virtual reality (VR) is a three-dimensional, computer-generated environment which can be explored and interacted with by a person. This person becomes part of a virtual world and/or is immersed within this environment and whilst there, is able to manipulate objects and/or perform a series of actions.

One VR-based computer-generated environment includes a shared virtual world such as the “metaverse.” A shared virtual world is an immersive hypothetical virtual world that users experience and explore by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc.

### SUMMARY

A computer-implemented method, according to one embodiment, includes outputting, from a first user device associated with a first user that owns a first portion of land in a metaverse to a second user device associated with a second user that owns a second portion of land in the metaverse, a first request for being defined as a first neighbor of the first user. In response to a determination that an acceptance has been received from the second user device to be defined as the first neighbor of the first user, an adapter is caused to be added to a sub-portion of the first portion of land and a sub-portion of the second portion of land. The method further includes generating a definition of neighbors of the first portion of land, the definition including the first neighbor. The definition is caused to be recorded in a predetermined database.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIGS. 3A-3H are depictions of a metaverse environment, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for defining borders and neighbors in a metaverse.

In one general embodiment, a computer-implemented method includes outputting, from a first user device associated with a first user that owns a first portion of land in a metaverse to a second user device associated with a second user that owns a second portion of land in the metaverse, a first request for being defined as a first neighbor of the first user. In response to a determination that an acceptance has been received from the second user device to be defined as the first neighbor of the first user, an adapter is caused to be added to a sub-portion of the first portion of land and a sub-portion of the second portion of land. The method further includes generating a definition of neighbors of the first portion of land, the definition including the first neighbor. The definition is caused to be recorded in a predetermined database.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as metaverse border and neighbor definition determination module of block 150 for defining borders and neighbors in a metaverse. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

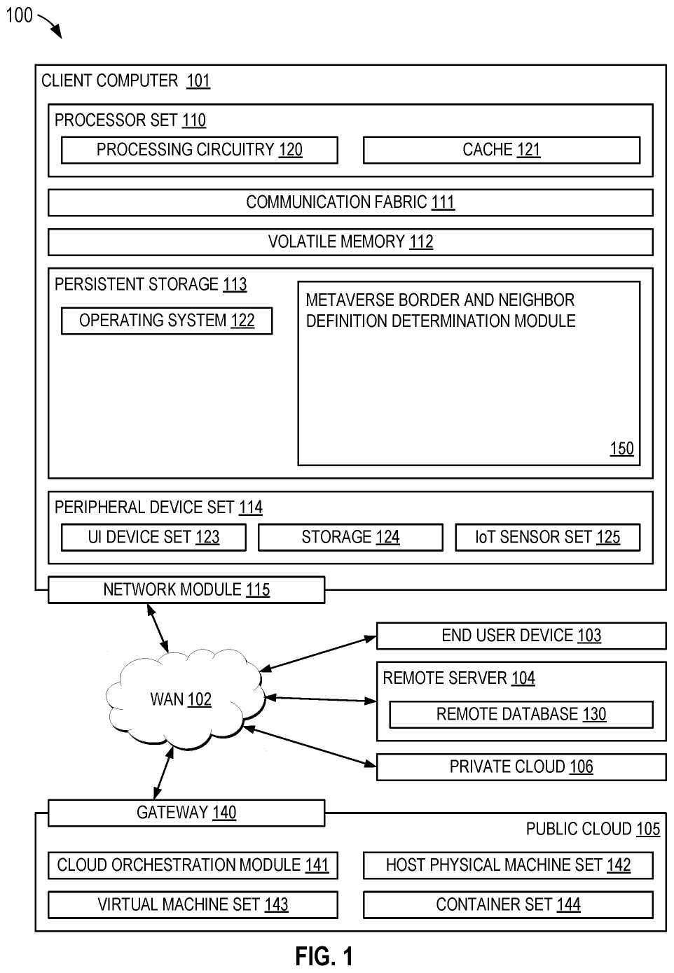

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, virtual reality (VR) is a three-dimensional, computer-generated environment which can be explored and interacted with by a person. This person becomes part of a virtual world and/or is immersed within this environment and whilst there, is able to manipulate objects and/or perform a series of actions.

One VR-based computer-generated environment includes a shared virtual world such as the “metaverse.” A shared virtual world is an immersive hypothetical virtual world that users experience and explore by utilizing user devices. These user devices may include, e.g., a VR headset, an augmented reality (AR) headset, VR glasses, VR rooms that include a plurality of display walls, etc. Within a shared virtual world, users are able to interact with other users, e.g., virtually meet, converse, perform virtual activities, collaborate, etc.

In a conventional metaverse, the corresponding locations of lands are fixed, and the neighbor of a land is fixed. With virtual land of the metaverse able to be purchased, held and sold, this causes some lands to be relatively very expensive, while some other lands are sold and/or valued relatively cheaply. While the price of a given portion of land may be a limitation to users of the metaverse, users of a conventional metaverse are unable to define neighbors or reach a target land in the metaverse by virtually walking. Instead, users are limited to reaching a target portion of the land in the metaverse by virtually teleporting and/or inputting an address of the target directly into a user device used by the user to virtually explore the metaverse. However, these users are still unable to define neighbors in their view, define what the neighbors look like, or even interact with users that own proximate portions of land.

In sharp contrast to the deficiencies described above, the techniques of embodiments and approaches described herein include selectively causing an adapter to be added to lands owned by users agree to be neighbors, and generating a definition of neighbors in the metaverse. This way, users of the metaverse are able to interact with one another. Furthermore, such definitions may be shared as a template between users in order to reduce an amount of processing that would otherwise be performed on a computer used by a user that is not provided access to such definitions (and instead has to resort to defining the neighbors from scratch).

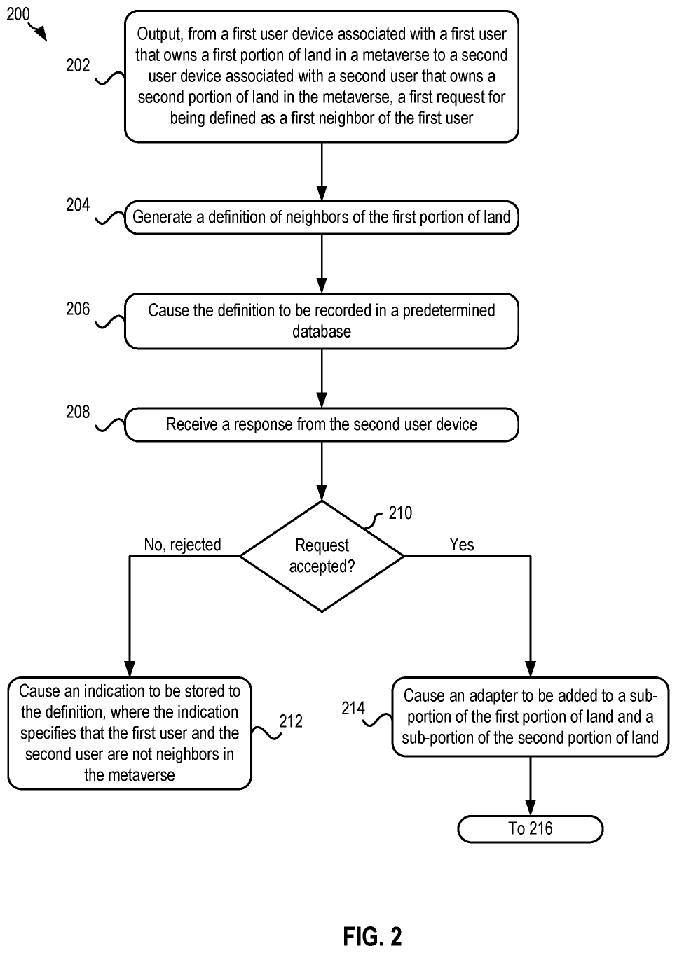

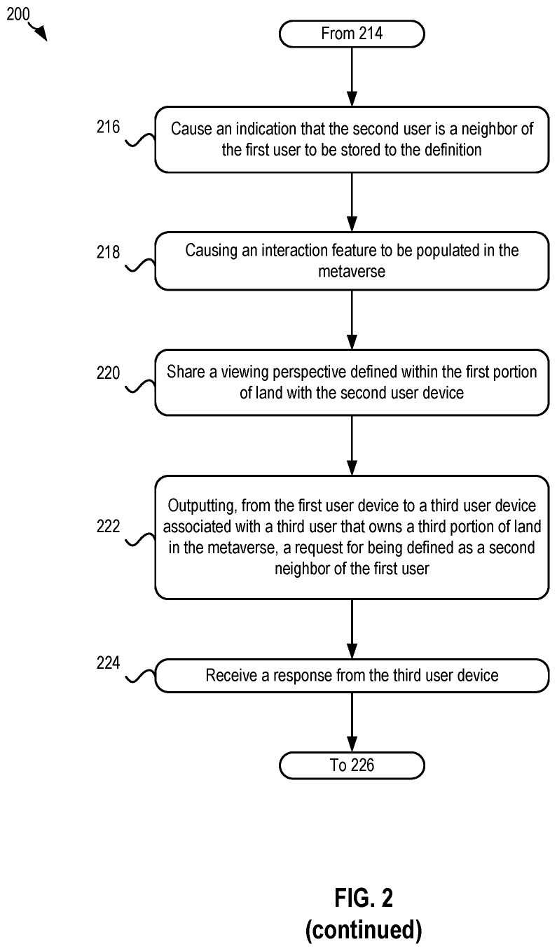

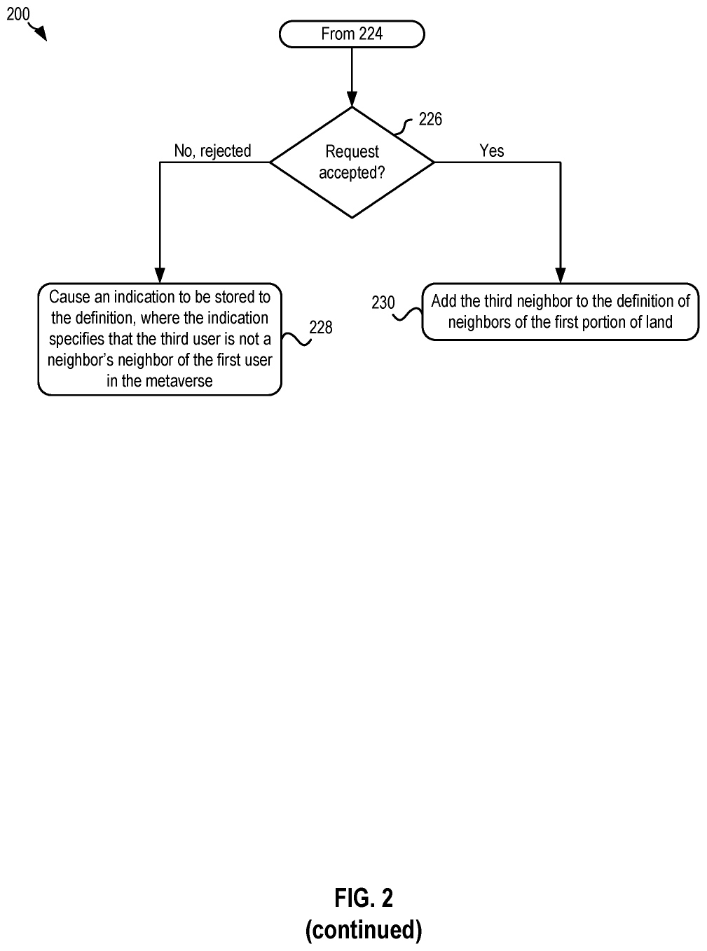

Now referring to FIG. 2, a flowchart of a method 200 is shown according to one embodiment. The method 200 may be performed in accordance with the present invention in any of the environments depicted in FIGS. 1-3H among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may be performed with respect to a metaverse. The metaverse may be actively explored by a plurality of users, e.g., the first user, a second user, a third user, etc., using at least one user device associated with the user, e.g., a VR device, an AR device, a computer, VR glasses, etc. The metaverse may about resemble reality in some approaches, e.g., buildings, landmarks, a location preselected by a user entering the metaverse, etc. In some approaches, the users may additionally and/or alternatively be able to navigate the metaverse using, e.g., a controller, a walking treadmill, a stationary bicycle, etc. While interacting within the metaverse, one or more users are, in some approaches, enabled to interact with one another, e.g., chat, dance, play board games, drive in a car together, etc. Users may use user devices to initiate such interactions, e.g., walk up to other users, start an audible conversation with another user visible in the metaverse, output a discussion request, etc. Users interacting within the metaverse may each have an associated avatar. The avatar may, in some approaches, be based on the actual appearance of the user. In some other approaches, the avatar may not be based on an actual appearance of the user so as to maintain privacy of the user while interacting within the metaverse. The avatars may be assigned to the users of the metaverse by the infrastructure provider of the metaverse, be randomly assigned to the users, be customizable by the users, etc.

In some approaches, users using the metaverse may privately own virtual land in the metaverse. For example, a first user using a first user device may own a first portion of land in a metaverse, a second user using a second user device may own a second portion of land in a metaverse, etc. Each of these privately owned portions of land in the metaverse may border one or more other privately owned portions of land and/or public portions of land of the metaverse. In some approaches, a user may be prevented from virtually navigating on private land in the metaverse that they do not own but may be allowed to virtually navigate on land in the metaverse that they privately own and be allowed to virtually navigate on public land in the metaverse. Accordingly, some views of a portion of land privately owned in the metaverse may be restricted in the metaverse. For example, in some approaches, assuming that a first user owns a first portion of land in the metaverse, and a second user owns a second portion of land in the metaverse, the first user may be unable to obtain a viewing perspective of the first portion of land taken from the second portion of land. In other words, without gaining permission to travel on the second portion of land, the first user is unable to view their property from a viewing perspective that the second user has while on the second portion of land. Various approaches described below enable neighbor interactions and definitions for streamlining user interaction in the metaverse.

With continued reference to FIG. 2, operation 202 includes outputting, from a first user device associated with a first user that owns a first portion of land in a metaverse to a second user device associated with a second user that owns a second portion of land in the metaverse, a first request for being defined as a first neighbor of the first user. In some approaches, some portions of land owned by a user of the metaverse may not include any neighbors until the user accepts one or more neighbors. For example, in some approaches, initially, the first portion of land and the second portion of land may reside relatively near one another, e.g., be only separated by a predetermined default size portion of public land, but not have a shared border. For context, a “shared border” considers the property lines of the properties with respect to one another, e.g., a portion of a border of a first portion of land may be shared by touching a portion of a border of a second portion of land. Assuming that the first portion of land is a rectangular plot of land, and the second portion of land is a rectangular plot of land, it may be assumed that none of the sides of the first portion of land touch the sides of the second portion of land. In some other approaches, the first portion of land and the second portion of land may be geographically separated in the metaverse, e.g., beyond a viewing distance in the metaverse. Accordingly, in some approaches, the first request may be for the second user to agree to position the second portion of land immediately next to the first portion of land, e.g., have at least some common property borders. In some other approaches, the first request may additionally and/or alternatively be for the second user to agree to adding a predetermined adapter to a sub-portion of the first portion of land and a sub-portion of the second portion of land to thereby enable interaction between the first user and the second user in the metaverse. Note that such adapters will be described in further detail elsewhere herein, e.g., see operation 214. In yet another approach, the first request may additionally and/or alternatively be for the second user to agree for the second user to be able to view the first portion of land and the first user to be able to view the second portion of land. In yet some further approaches, the first request may additionally and/or alternatively be for the second user to agree for the first user and the second user to be documented as neighbors, e.g., in a generated definition of neighbors in the metaverse.

In some approaches, requests sent between users of the metaverse may include information that may be appended to the request, and that defines the request. For example, in some approaches, the request may include information that specifies a predetermined, limited amount of time that the second user would be defined as a neighbor of the first user, e.g., one hour, one day, one year, etc. In some other approaches, the request additionally and/or alternatively may include information that specifies terms that the second user and/or the first user would be responsible for during a period of time that the second user is defined as a neighbor of the first user, e.g., financial terms, work terms such as a covenant for maintaining the portions of land, policies with respect to sharing information about the other user with third parties such as another user of the metaverse, what sub-portions of the portions of land would share a border, what types of adapters to add to the each sub-portion of land, etc.

A response is received, e.g., by the first user device, by a user device that is hosting the metaverse, by a computer that caused the first request to be output by the first device, etc., from the second user device that includes an indication, e.g., answer, of whether the second user accepts the first request, e.g., see operation 208.

A determination may be made as to whether the received response is an acceptance or a rejection of the first request, e.g., see decision 210. In some approaches, techniques that would become apparent to one of ordinary skill in the art may be used to extract such a determination from the received response. For example, in some approaches, natural processing language (NLP) techniques may be used to determine whether the received response includes an acceptance, a rejection, a request for more information, a counter-request that modifies some of the terms included in the first request, etc.

In response to a determination that the first request for the second user to be defined as the first neighbor of the first user is rejected, e.g., as illustrated by the “No, rejected” logical path of decision 210, an indication that the second user is not neighbors with the first user may be generated and stored. In some preferred approaches, a definition of neighbors of the first portion of land may be generated and recorded, e.g., see operation 204 and operation 206, in a predetermined database, e.g., which may be stored on non-volatile memory or volatile memory. In some approaches, the definition is recorded on a predetermined blockchain, the ledger of which may be selectively distributed to, e.g., all users of the metaverse, only neighbors of the first user, only neighbors and neighbor's neighbors of the first user, only neighbors of the second user, neighbors and neighbor's neighbors of the second user, etc.

In some preferred approaches, in response to a determination that a rejection has been received from the second user device to be defined as the first neighbor of the first user, an indication is caused, e.g., instructed to a device that has editing control of the definition, to be stored to the definition, e.g., see operation 212. In one or more of such approaches, the indication preferably specifies that the first user and the second user are not neighbors in the metaverse. Note that this indication may, in some approaches, be only defined with respect to the first portion of land and the second portion of land, while other portions of land owned by the first and second users, e.g., a third portion of land in the metaverse and a fourth portion of land in the metaverse, may be used to define the first user and the second user as being neighbors in a different definition.

In response to a determination that an acceptance has been received from the second user device to be defined as the first neighbor of the first user, method 200 preferably includes performing one or more operations that define the first user and the second user to be neighbors with respect to the first portion of land and the second portion of land in the metaverse. In some approaches, a first of such operations that define the first user and the second user to be neighbors with respect to the first portion of land and the second portion of land in the metaverse includes causing an indication that the second user is a neighbor of the first user to be stored to the generated definition, e.g., see operation 216.

In response to the determination that the first request for the second user to be defined as the first neighbor of the first user is accepted, e.g., as illustrated by the “Yes” logical path of decision 210, an adapter is caused to be added to a sub-portion of the first portion of land and a sub-portion of the second portion of land, e.g., see operation 214. In some approaches, causing the adapter to be added to a sub-portion of the first portion of land and a sub-portion of the second portion of land includes instructing a computer that hosts the metaverse to add a predetermined structure to the sub-portion of the first portion of land and the sub-portion of the second portion of land. For example, the predetermined structure may in some approaches, include, e.g., a bridge, an elevator, an escalator, a conveyor belt, a water slide, etc. It should be noted that the structure may lead from the first portion of land to the second portion of land at the sub-portions, e.g., such as at the common border of the first portion of land and the second portion of land. In some other approaches, the predetermined structure may additionally and/or alternatively include an athletic component, e.g., a tennis net, a ping pong net, a shared athletic court, a shared athletic field, etc. The predetermined structure may, in some other approaches, additionally and/or alternatively include a walking path and/or a channel of water that is located around walkways.

In some approaches, a plurality of adapter options are caused to be output to the first user device and/or the second user device in response to the determination that the acceptance has been received from the second user device to be defined as the first neighbor of the first user. The first user device and/or the second user device may be authorized to vote on which of the adapters to add to the portions of land. In response to a determination that the authorized user device(s) have returned a response with an indication of adapter(s) to include in the portions, the indicated adapter(s) may be determined from the received response and caused to be added to the sub-portion of the first portion of land and the sub-portion of the second portion of land.

In some approaches, causing the adapter to be added to the sub-portion of the first portion of land and the sub-portion of the second portion of land may result in the first portion of land and the second portion of land sharing a common border where the first portion of land and the second portion of land did not share the common border before the addition of the adapter. For example, in some approaches, the adapter may fill in public portions of land that exist between the first portion of land and the second portion of land. In one or more of such approaches, the first user and the second user may inherit and/or have to purchase the public land, and the portion of assumed land may thereafter be equally owned by the first user and the second user. In response to a determination that the first user and second user thereafter relinquish being neighbors with one another, the adapters may be removed from the equally owned portion of land, and the portion of land may return to a public portion of land. In some other approaches, the first portion of land and the second portion of land may have a shared border that at least includes and extends along the sub-portion of the first portion of land and the sub-portion of the second portion of land before and after the acceptance of the first request. In one or more of such approaches, the adapter may be caused to be added at the location of the sub-portions. In some other approaches, the adapter may be caused to be added at randomly determined portions of the first portion of land and the second portion of land, e.g., to prevent any disagreement between the neighbors about the location for the adapter(s).

The adapter preferably supports interactions between users and their neighbors and optionally enables the first user and the second user to interact with one another in the metaverse. For example, in some approaches, method 200 includes causing a predetermined interaction feature associated with the adapter to be populated in the metaverse, e.g., see operation 218. The interaction feature, in some approaches, is a game that involves the adapter. For example, in one or more of such approaches, the game may be a tennis match and the adapter may be a tennis court and tennis court net that is located at the sub-portion of the first portion of land and the sub-portion of the second portion of land. The interaction feature may additionally and/or alternatively include an invitation engine that is configured to be controlled by the first user and/or the second user using the user devices to initiate a neighbor to come visit their property. In yet another approach, the interaction feature may additionally and/or alternatively include enabling a discussion between the first user and the second user while an avatar of the first user is standing on the first portion of land and an avatar of the second user is standing on the second portion of land in the metaverse. Enabling the discussion may include, e.g., routing audio files from a user device of one of the users speaking to a user device of the neighbor that is listening during the discussion.

Another operation that defines the first user and the second user as being neighbors with respect to the first portion of land and the second portion of land in the metaverse includes sharing viewing perspectives among users determined to be neighbors. For example, in some approaches, method 200 includes sharing a viewing perspective defined within the first portion of land with the second user device in response to the determination that the acceptance has been received from the second user device, e.g., see operation 220. In contrast, method 200 may include not sharing the viewing perspective defined within the first portion of land with the second user device in response to a determination that a rejection has been received from the second user device to be defined as the first neighbor of the first user. As mentioned elsewhere above, a viewing perspective of the first portion of land may be a viewing perspective that a user virtually present on the first portion of land in the metaverse sees. Because the first portion of land in the metaverse and the second portion of land in the metaverse are private property, in some approaches, viewing perspectives associated with these portions of land (and any other privately owned portions of land) may be restricted and only selectively provided to another user in response to a determination that the owner user and the user provided the viewing perspective have agreed to be neighbors with one another with respect to a predetermined portion of property in the metaverse.

As a result of sharing the viewing perspective defined within the first portion of land with the second user device, the second device preferably is able to toggle between a first viewing perspective that a user virtually present on the first portion of land in the metaverse sees and a second viewing perspective that a user virtually present on the second portion of land in the metaverse sees. For example, subsequent to sharing the viewing perspective defined within the first portion of land with the second user device, in response to a determination that a request for viewing the viewing perspective defined within the first portion of land has been received from the second user device, the second user device may be allowed to access the first portion of land, e.g., using the adapter, and use the shared viewing perspective. In another approach, subsequent to sharing the viewing perspective defined within the first portion of land with the second user device, in response to a determination that a request for viewing the viewing perspective defined within the first portion of land has been received from the second user device, an avatar associated with the second user may be virtually teleported to the second portion of land and the second user device may be allowed to access, e.g., output an associated viewing feed to, the shared viewing perspective.

Another operation that defines the first user and the second user as being neighbors with respect to the first portion of land and the second portion of land in the metaverse includes adding at least one policy associated with the first user and the second user being neighbors with respect to the first portion of land and the second portion of land to the definition. In some preferred approaches, the policy may be based on information that was described elsewhere above to optionally be included in the first request. For example, the policy may define a predetermined limited amount of time that the second user would be defined as a neighbor with the first user, terms that the second user and/or the first user would be responsible for during a period of time that the second user is defined as a neighbor of the first user, etc. In some other approaches, the policy additionally and/or alternatively indicates the adapters and/or interaction features that have been added to the first portion of land and the second portion of land. This way, the definition may be shared with a third user device associated with a third user, and another user can use at least some portions of the definition to generate their own definition of their neighbors which may include the first and/or the second user. For example, the definition may be used as a template that is edited using the third user device to generate a new view of one or more of the neighbors of the third user. It should be noted, that by generating definitions of neighbors within the metaverse, a relative extent of processing operations that would otherwise be performed to virtually build out portions of land in the metaverse is reduced. This is because the generated definition is used as a template to thereby reduce an amount of computer computational operations and processing that would otherwise be performed by a user device in developing a portion of land without access to such a definition.

Method 200 may, in some approaches, additionally and/or alternatively include potentially defining further users as neighbors of the first user, e.g., a third user that owns a third portion of land in the metaverse and is associated with a third user device. For example, operation 222 includes outputting, from the first user device to the third user device, a request for being defined as a second neighbor of the first user. The location of the third portion of land with respect to the first portion of land and/or the second portion of land may depend on the approach. For example, in some approaches, the third portion of land and the first portion of land do not have a shared border, but the third portion of land and the second portion of land may have a shared border along a sub-portion of the third portion of land and a sub-portion of the second portion of land. In other words, in such an example, the second user and the third user may be neighbors based on the second portion of land being directly adjacent to the third portion of land, and the first user and the second user may be neighbors based on the first portion of land being directly adjacent to the second portion of land, but the first user may not be neighbors with the third user based on the first portion of land being, at least at the time the request is sent, not directly adjacent to the third portion of land. Accordingly, in some approaches, the request for being defined as a second neighbor of the first user may, in some approaches, be a request for the second user to be defined as a neighbor's neighbor of the first user with respect to the first portion of land and the second portion of land. Techniques described elsewhere above with respect to sending the first request may be adapted for sending the second request, e.g., the request for being defined as a second neighbor of the first user.

A response to the second request may be received from the third user device, e.g., see operation 224. A determination may be made as to whether the response to the second request indicates that the third user accepts the first user's request for being defined as a second neighbor of the first user, e.g., see decision 226. In response to a determination that a rejection has been received from the third user device, e.g., as illustrated by the “No, rejected” logical path of decision 226, method 200 includes causing, e.g., instructing, an indication to be stored to the definition, e.g., see operation 228, where the indication specifies that the third user is not a neighbor, e.g., a neighbor's neighbor in some approaches, of the first user in the metaverse. In response to a determination that an acceptance has been received from the third user device to be defined as the second neighbor of the first user, e.g., as illustrated by the “Yes” logical path of decision 226, the second neighbor is added to the definition of neighbors of the first portion of land, e.g., see operation 230.

In one or more approaches in which the first portion of land and the third portion of land share a common border subsequent to the determination that an acceptance has been received from the third user device to be defined as the second neighbor of the first user, one or more of the operations that define the first user and the second user to be neighbors with respect to the first portion of land and the second portion of land in the metaverse may be performed with respect to the first user and the third user. In contrast, in some other approaches, assuming that the first portion of land and the third portion of land do not share a common border subsequent to the determination that an acceptance has been received from the third user device to be defined as the second neighbor of the first user, the third user is defined as the first user's neighbor's neighbor with respect to the first portion of land and the third portion of land. In one or more of such approaches, method 200 optionally includes performing one or more predetermined operations that define the third user as the the first user's neighbor's neighbor with respect to the first portion of land and the third portion of land. For example, in some approaches, one of such predetermined operations may include the first user and the third user exchanging perspective views of their portions of the land. An adapter may additionally and/or alternatively be caused to be added to a sub-portion of the first portion of land and a sub-portion of the third portion of land. According to various illustrative approaches, the adapter may include, e.g., landing pads to use for virtually flying from the sub-portion of the first portion of land to the sub-portion of the third portion of land and vice versa, a bridge that leads from the first portion of land and the third portion of land that passes through the second portion of land only subsequent to gaining permission from the second user, an athletic component, etc. As indicated above, for some approaches in which the third user is the first user's neighbor's neighbor, the process of causing an adapter to be added to a sub-portion of the first portion of land and a sub-portion of the third portion of land may involve gaining permission, e.g., a lease, that allows the second portion of land to be used for connecting the first portion of land with the third portion of land. In contrast, in response to a determination that such permission is not gained, e.g., rejected, one or more adapters that involve use of the second portion of land may be removed from a plurality of adapter options that are caused to be output to the first user device and/or the third user device for selecting an adapter from.

As a result of implementing the techniques of embodiments and approaches described herein in a metaverse environment, users of the metaverse are not limited by fixed borders of land. This promotes collaboration among users in the metaverse, which is beneficial and promotes exploration and educational enrichment particularly to users in the world that are not otherwise in a financial and/or geographical location that would provide such benefits. Furthermore, the techniques described herein ensure that neighbors are dynamic, and that users can enjoy the metaverse in their own way. This in turn ensures that friends can become neighbors easily and build respective regions based on dynamic relationships, which is not necessarily guaranteed in the real world. These techniques may, in some approaches, be implemented by an entity that provides metaverse solutions.

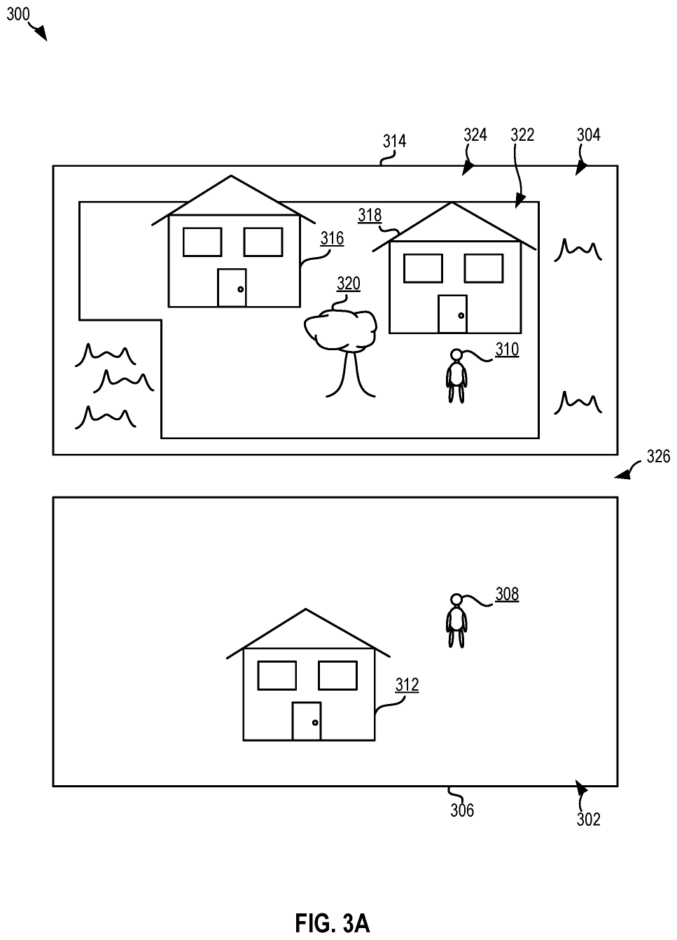

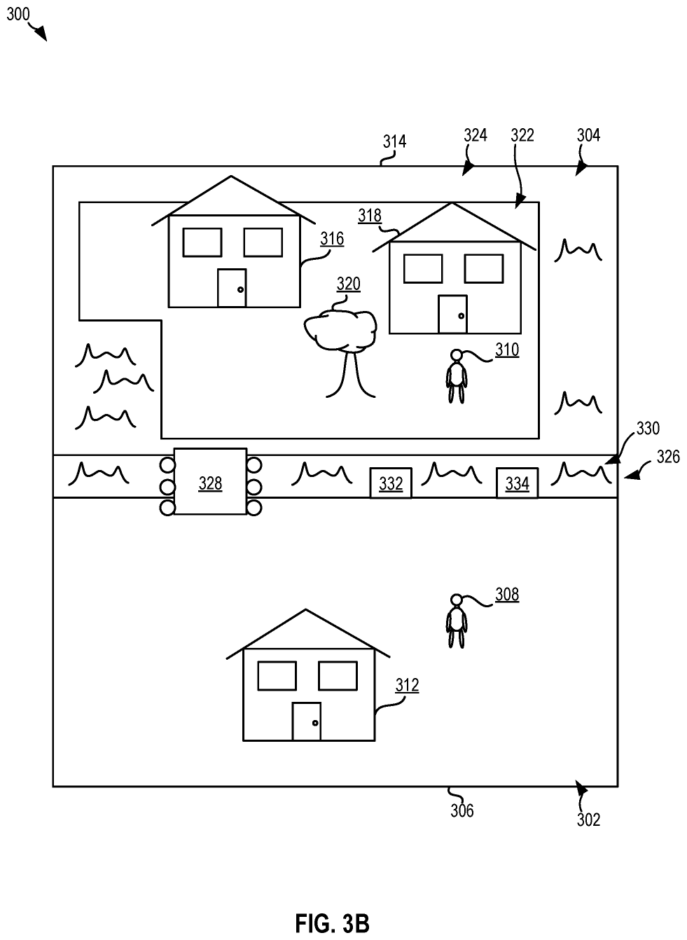

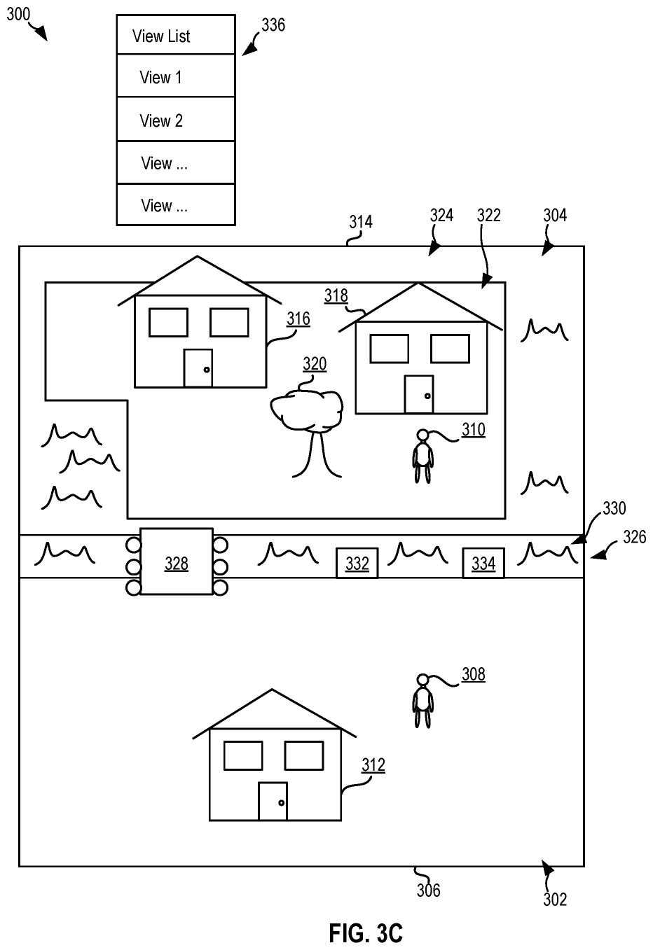

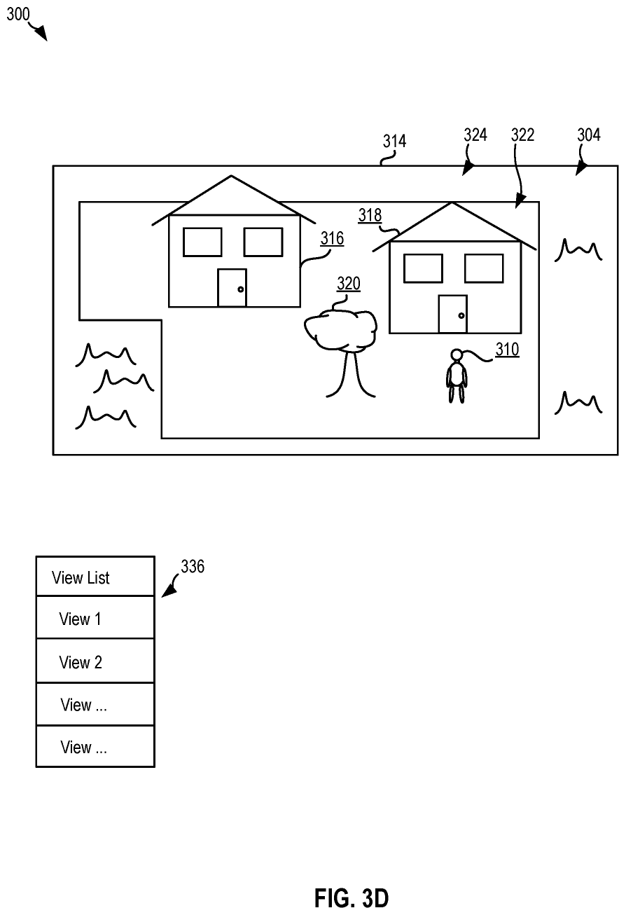

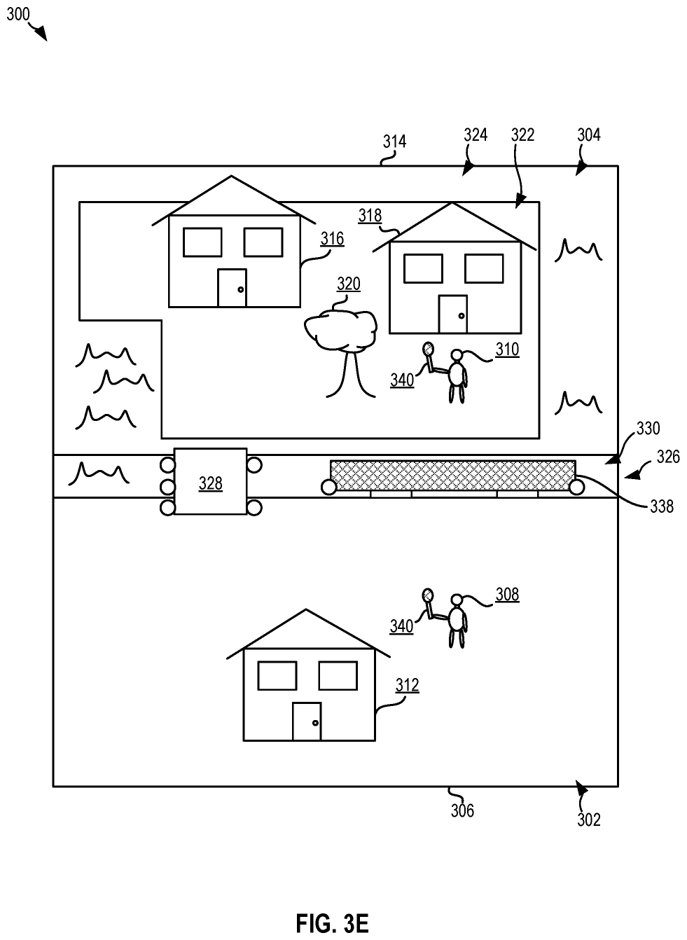

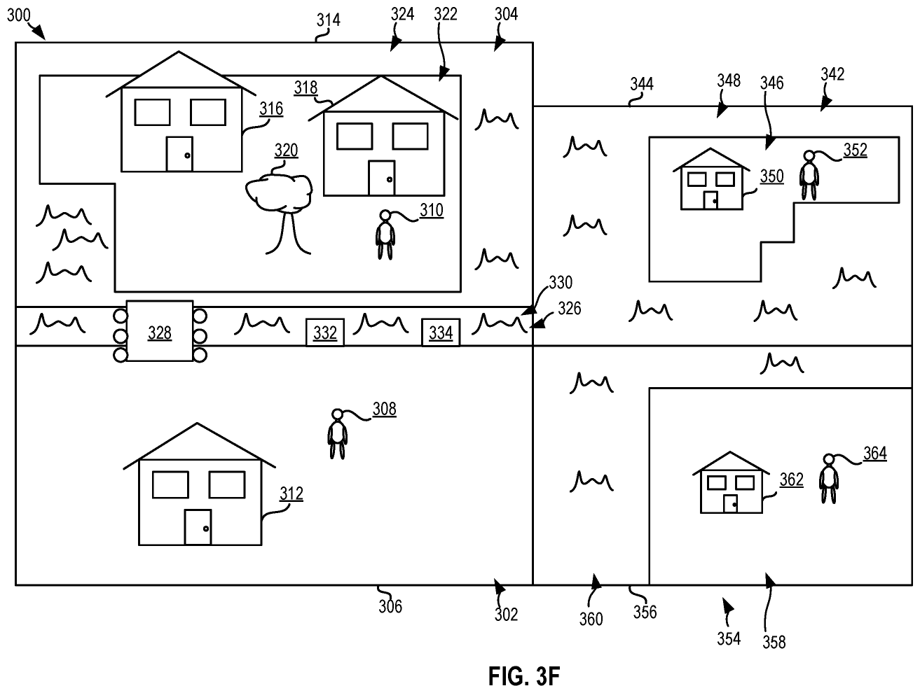

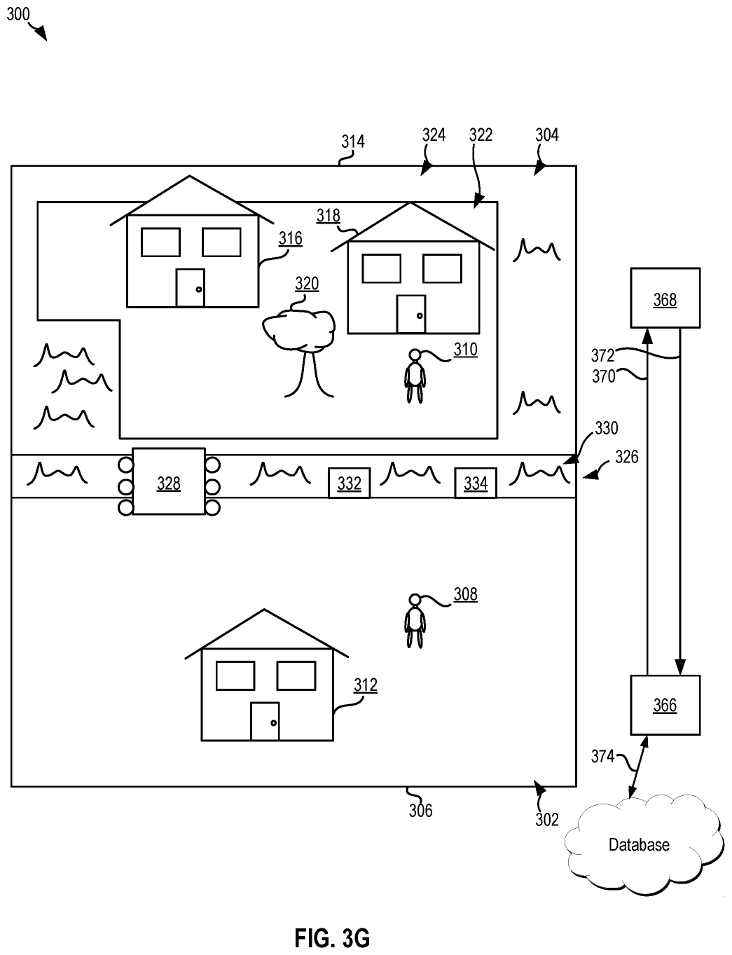

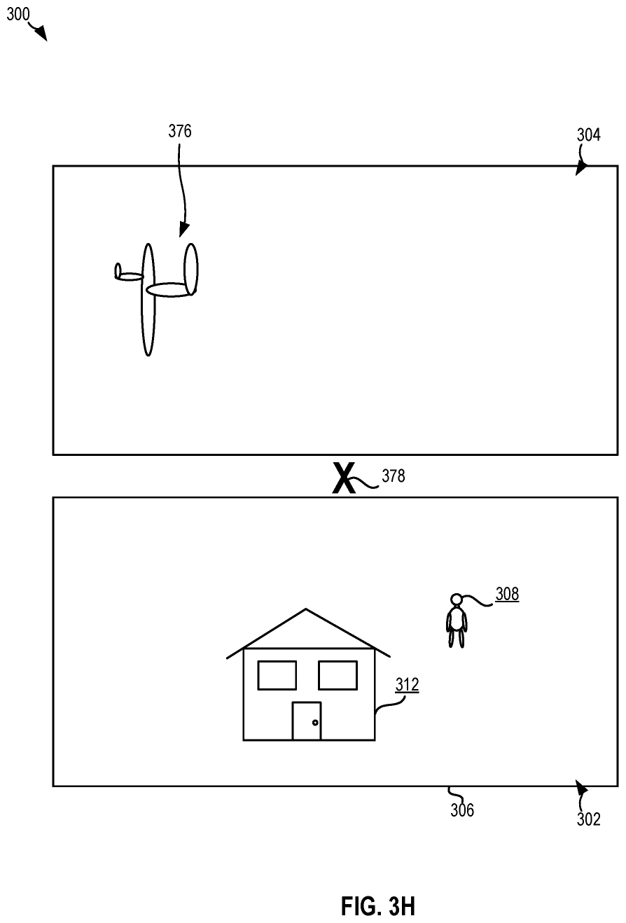

FIGS. 3A-3H depict metaverse environment 300, in accordance with several embodiments. As an option, the present metaverse environment 300 may be implemented in conjunction with features from any other embodiment listed herein, such as those described with reference to the other FIGS. Of course, however, such metaverse environment 300 and others presented herein may be used in various applications and/or in permutations which may or may not be specifically described in the illustrative embodiments listed herein. Further, the metaverse environment 300 presented herein may be used in any desired environment.

Referring first to FIG. 3A, the metaverse environment 300 includes a first portion of land 302 and a second portion of land 304 in a metaverse. The first portion of land is owned by a first user, e.g., see avatar 308 of the first user, associated with a first user device, and the second portion of land is owned by a second user, e.g., see avatar 310 of the second user, associated with a second user device. The first portion of land 302 is defined by a first perimeter boundary 306, and includes a house 312. The second portion of land 304 is defined by a second perimeter boundary 314, and includes a first house 316, a second house 318, a tree 320, a land portion 322 of the second portion of the land 304 and a water portion 324 of the second portion of the land 304. The first portion of land 302 is physically separated from the second portion of land 304, e.g., see center portion of land 326.

A first request may, in some approaches, be output from the first user device to the second user device. Such requests allow the user to freely set their preferred neighbors. The first request may request the second user to agree to be a neighbor of the first neighbor with respect to the first portion of land and the second portion of land. In response to a determination that a rejection has been received from the second user device with respect to the first request, the second user is not defined as the first neighbor of the first user. This information may be stored in a generated definition of neighbors of the first portion of land which may be recorded in a predetermined database.

Referring now to FIG. 3B, in response to a determination that an acceptance has been received from the second user device to be defined as the first neighbor of the first user, an adapter may, in some approaches, be caused to be added to a sub-portion of the first portion of land and a sub-portion of the second portion of land. In some approaches, the center portion of land 326 is used as an adapter area at the border of the portions of land in order to adapt with neighbors. For example, the adapter area may be used to define at least one way to connect with neighbors, e.g., a bridge adapter 328. The bridge adapter may then be used by the users to gain a viewing perspective of their respective neighbor's portion of land and/or to enter the neighbor's portion of land. For example, a bridge adapter 328 may be used by avatars to walk to a neighbor's portion of land. Accordingly, the adapter adds some objects to connect neighbors relatively smoothly. Further examples of adapters added in FIG. 3B include a channel of water 330 and portions of land 332 and 334.

Referring now to FIGS. 3C-3D, different viewing perspectives of the metaverse environment 300 are represented according to various embodiments. Each portion of land has a respective unique view that can be viewed by an owning user of the portion of land, in addition to any users that the viewing perspective is shared with. For example, a viewing perspective at different portions of land may be different as different portions of land may define different neighbors. In some approaches, these different views may be maintained and used by creating a special environment for each of the neighbors of a given user, e.g., creating a game copy of the metaverse environment. With specific reference now to FIG. 3C, a viewing selection feature 336 may be output to one or more user devices to be used for selecting a viewing perspective to output to a user device. For example, in FIG. 3C, a first viewing perspective of the metaverse environment 300, e.g., see “View 1”, may be used to observe a view from the first portion of land. In some approaches, in response to the definition of neighbors of the first portion of land including the first neighbor of the first user, the first user is able to view the second portion of land. In contrast, in FIG. 3D, a second viewing perspective of the metaverse environment 300, e.g., see “View 2”, may be used to observe a view from the second portion of land. In some approaches, in response to the second user not yet being provided a viewing perspective of the first portion of land, the first portion of land is not able to be seen from the second viewing perspective. However, in some approaches, the second user may be able to view the first portion of land from the second viewing perspective in response to requesting and/or receiving a shared viewing perspective from the first user device.

In FIG. 3E, an interaction feature is caused to be populated in the metaverse environment. In some approaches, the interaction feature is a game that involves the adapter. For example, in FIG. 3E, a tennis net 338 is added to the center portion of land 326, and each of the avatars are provided with a tennis racket 340 for enabling the first user and the second user to play tennis using their user devices. Accordingly, the adapter and interaction features support interactions between the users as neighbors of one another with respect to the first portion of land and the second portion of land. In some approaches, the users defined as neighbors may agree to a specific view, e.g., addition of selected interaction features in the metaverse environment, and interactions during the gameplay including the user's actual physical movements may be translated to the avatars to enable the users to virtually play together as neighbors relatively easily.

Referring now to FIG. 3F, the metaverse environment includes a third portion of land 342 defined by a perimeter boundary 344, and having land 346, water 348 and a house 350. The third portion of land is owned by a third user that uses a third user device and is represented in the metaverse by avatar 352. Furthermore, the metaverse environment includes a fourth portion of land 354 defined by a perimeter boundary 356, and having land 358, water 360 and a house 362. The fourth portion of land is owned by a fourth user that uses a fourth user device and is represented in the metaverse by avatar 364.

A second request may be output from the first user device to the third user device, and a third request may be output from the first user device to the fourth user device. For context, the second request may be a request for the third user to be defined as a second neighbor, e.g., a neighbor's neighbor, of the first user with respect to the first portion of land and the third portion of land. Furthermore, the third request may be a request for the fourth user to be defined as a third neighbor of the first user with respect to the first portion of land and the fourth portion of land. It should be noted that the neighbor and neighbor's neighbor may only have an impact on the first user's viewing perspective in some approaches, and none of the viewing perspectives of the other users are impacted as a result of generating the definition of neighbors of the first portion of land and/or adding adapters in the metaverse with respect to the first portion of land. Accordingly, each user may develop and enjoy their own viewing perspective in the metaverse, which may optionally incorporate the viewing perspective of other users as a result of such viewing perspectives being optionally shared among the users of the metaverse.

Referring now to FIG. 3G, the operative principle that definitions of neighbors can be shared among user devices is illustrated according to one embodiment. For example, a definition of neighbors and/or a viewing perspective of the first portion of land may be shared by a first user device 366 associated with the first user to a second user device 368 associated with the second user, e.g., see sharing operation 370. Similarly, a definition of neighbors and/or a viewing perspective of the second portion of land may be shared by the second user device to the first user device, e.g., see sharing operation 372. These definitions may additionally and/or alternatively be recorded in a predetermined database, e.g., see Database and recording operation 374. This sharing provides user devices with editable files that may be used as a template file for building out another portion of land and preserving processing resources in doing so. This way, another user can use a user device to build a view of the metaverse environment based on another user's design and optionally does not have to start from scratch.

In some embodiments, a user may be enabled to input characteristics that define the policy of being a neighbor with the first user. For example, the policy can be “accept anyone”, “accept someone”, “reject anyone”, “reject someone”, “need confirmation”, etc. A user can additionally and/or alternatively choose to be or not to be a neighbor of someone, to thereby enable the privacy of the user to be protected. Referring now to FIG. 3H, in some approaches, the first portion of land may have a policy that only portions of land with relatively mild climates are accepted as neighbors. Based on this policy, subsequent to a request to be defined as a neighbor of a fifth portion of land being received from a fifth user device, the request may be rejected, e.g., see rejection response 378, in response to a determination that a climate of the fifth portion of land is not relatively mild. For example, in response to a determination that the fifth portion of land is a desert, e.g., see cactus 376, a determination may be made that the fifth portion of land does not satisfy the policy associated with the first portion of land.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
outputting, from a first user device associated with a first user that owns a first portion of land in a metaverse to a second user device associated with a second user that owns a second portion of land in the metaverse, a first request for being defined as a first neighbor of the first user;
in response to a determination that an acceptance has been received from the second user device to be defined as the first neighbor of the first user, causing an adapter to be added to a sub-portion of the first portion of land and a sub-portion of the second portion of land;
generating a definition of neighbors of the first portion of land, the definition including the first neighbor; and
causing the definition to be recorded in a predetermined database.

2. The computer-implemented method of claim 1, wherein the adapter is selected from the group comprising: a bridge that leads from the first portion of land and the second portion of land, an athletic component, a path, and a channel of water.

3. The computer-implemented method of claim 1, wherein the first portion of land and the second portion of land have a shared border along the sub-portion of the first portion of land and the sub-portion of the second portion of land.

4. The computer-implemented method of claim 1, comprising:
outputting, from the first user device to a third user device associated with a third user that owns a third portion of land in the metaverse, a second request for being defined as a second neighbor of the first user; and
in response to a determination that an acceptance has been received from the third user device to be defined as the second neighbor of the first user, adding the second neighbor to the definition of neighbors of the first portion of land.

5. The computer-implemented method of claim 4, wherein the third portion of land and the first portion of land do not have a shared border, wherein the third portion of land and the second portion of land have a shared border.

6. The computer-implemented method of claim 1, comprising: sharing a viewing perspective defined within the first portion of land with the second user device in response to the determination that the acceptance has been received from the second user device.

7. The computer-implemented method of claim 1, comprising: in response to a determination that a rejection has been received from the second user device to be defined as the first neighbor of the first user: causing an indication to be stored to the definition, wherein the indication specifies that the first user and the second user are not neighbors in the metaverse.

8. The computer-implemented method of claim 1, wherein the definition includes at least one policy of being a neighbor, and comprising: sharing the definition with a third user device associated with a third user.

9. The computer-implemented method of claim 1, comprising: causing an interaction feature to be populated in the metaverse, wherein the interaction feature is a game that involves the adapter.

10. A computer program product, the computer program product comprising a computer readable storage medium having program instructions embodied therewith, the program instructions readable and/or executable by a computer to cause the computer to:
output, from a first user device associated with a first user that owns a first portion of land in a metaverse to a second user device associated with a second user that owns a second portion of land in the metaverse, a first request for being defined as a first neighbor of the first user;
in response to a determination that an acceptance has been received from the second user device to be defined as the first neighbor of the first user, cause an adapter to be added to a sub-portion of the first portion of land and a sub-portion of the second portion of land;
generate a definition of neighbors of the first portion of land, the definition including the first neighbor; and
cause the definition to be recorded in a predetermined database.

11. The computer program product of claim 10, wherein the adapter is selected from the group comprising: a bridge that leads from the first portion of land and the second portion of land, an athletic component, a path, and a channel of water.

12. The computer program product of claim 10, wherein the first portion of land and the second portion of land have a shared border along the sub-portion of the first portion of land and the sub-portion of the second portion of land.

13. The computer program product of claim 10, the program instructions readable and/or executable by the computer to cause the computer to:
output, from the first user device to a third user device associated with a third user that owns a third portion of land in the metaverse, a second request for being defined as a second neighbor of the first user; and
in response to a determination that an acceptance has been received from the third user device to be defined as the second neighbor of the first user, add the second neighbor to the definition of neighbors of the first portion of land.

14. The computer program product of claim 13, wherein the third portion of land and the first portion of land do not have a shared border, wherein the third portion of land and the second portion of land have a shared border.

15. The computer program product of claim 10, the program instructions readable and/or executable by the computer to cause the computer to: share a viewing perspective defined within the first portion of land with the second user device in response to the determination that the acceptance has been received from the second user device.

16. The computer program product of claim 10, the program instructions readable and/or executable by the computer to cause the computer to: in response to a determination that a rejection has been received from the second user device to be defined as the first neighbor of the first user: cause an indication to be stored to the definition, wherein the indication specifies that the first user and the second user are not neighbors in the metaverse.

17. The computer program product of claim 10, wherein the definition includes at least one policy of being a neighbor, and the program instructions readable and/or executable by the computer to cause the computer to: share the definition with a third user device associated with a third user.

18. The computer program product of claim 10, the program instructions readable and/or executable by the computer to cause the computer to: cause an interaction feature to be populated in the metaverse, wherein the interaction feature is a game that involves the adapter.

19. A system, comprising:
a processor; and
logic integrated with the processor, executable by the processor, or integrated with and executable by the processor, the logic being configured to:
output, from a first user device associated with a first user that owns a first portion of land in a metaverse to a second user device associated with a second user that owns a second portion of land in the metaverse, a first request for being defined as a first neighbor of the first user; and
in response to a determination that an acceptance has been received from the second user device to be defined as the first neighbor of the first user, cause an adapter to be added to a sub-portion of the first portion of land and a sub-portion of the second portion of land;
generate a definition of neighbors of the first portion of land, the definition including the first neighbor; and
cause the definition to be recorded in a predetermined database.

20. The system of claim 19, wherein the adapter is selected from the group comprising: a bridge that leads from the first portion of land and the second portion of land, an athletic component, a path, and a channel of water.
